(19) United States
(12) Patent Application Publication
(10) Pub. No.: US 2007/0274738 A1
(43) Pub. Date: Nov. 29, 2007

(54) Conductive brush, process cartridge and image forming apparatus

(75) Inventors: Takeshi Watanabe, Yokohama-shi (JP); Masashi Takahashi, Yokohama-shi (JP); Mitsuaki Kouyama, Higashikurume (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: Kabushiki Kaisha Toshiba, Minato-ku (JP); Toshiba Tec Kabushiki Kaisha, Shinagawa-ku (JP)

(21) Appl. No.: 11/439,293

(22) Filed: May 23, 2006

(51) Int. Cl. G03G 15/30; G03G 15/02; G03G 21/00

(52) U.S. Cl. 399/149; 399/175; 399/353

(57) ABSTRACT

In the invention, oxidation-treated carbon black having good dispersibility is used to obtain a conductive brush having a uniform resistance even when it is finely processed. An image forming process is carried out by using the conductive brush, whereby abnormal discharge to a photoreceptor is suppressed, and an image defect due to charging unevenness is prevented from occurring without damaging the photoreceptor, so as to improve image quality. The photoreceptor is scraped uniformly and smoothly to prevent filming from occurring, whereby the maintenance property is improved.

### BACKGROUND OF THE INVENTION

1. Field of the Invention

The present invention relates to a conductive brush, which is used in a duplicator, a color printer and the like utilizing an electrophotographic system, and carries out charging, cleaning and disturbing of a toner image on an image carrying member, and also relates to a process cartridge and an image forming apparatus, which are equipped with the conductive brush.

2. Description of the Related Art

In an image forming apparatus, such as a duplicator and a printer, in recent years, a conductive brush is used for charging, cleaning of residual toner, and disturbing of a toner image on a photoreceptor. A brush using brush threads containing conductive carbon black dispersed uniformly in cellulose or the like has been used as the conductive brush. A brush using a composite of a conductive component formed of a thermoplastic polymer containing conductive fine particles, such as carbon black, and a nonconductive component containing a fiber-forming thermoplastic polymer has also been used.

In the case, for example, where a conductive brush is used as a charging brush, it should suppress charging unevenness from occurring. Accordingly, the conductive brush is demanded to have a uniform resistance. In order to obtain a uniform resistance, in the latter case of the conductive brush, for example, such a brush has been used that has a core/shell composite structure, in which the conductive component completely covers the nonconductive component, and contains a polyamide resin, an aromatic polyester resin or a polyolefin resin containing a monomer unit containing 10 or more carbon atoms as a major component, as the thermoplastic polymer constituting the conductive component and the thermoplastic polymer constituting the nonconductive component. Alternatively, such a brush has been used that contains conductive fibers containing a thermoplastic polymer containing from 15 to 50% by weight of conductive carbon black and having a monofilament fineness of from 1 to 15 dtex, and ultrafine fibers having a monofilament fineness of from 0.01 to 1 dtex, and has a number of interlace points of 10 per meter or more.

The conductive brush has high durability and is resistant to stain, as compared to a conductive roller having elasticity. However, the conductive brush suffers contact unevenness since it is in a fibrous form. As a result, strip unevenness occurs in a halftone image and the like, which may bring about deterioration in image quality.

In the case, for example, where a brush having a monofilament fineness of brush fibers of from 15 to 9 dtex is produced by using conventional conductive carbon black of pH 7.8 having not been subjected to an oxidation treatment as the conductive materials, relatively thick stripe charging unevenness occurs, which is conspicuous. When the monofilament fineness of the brush fibers is made smaller, the thickness of the stripe charging unevenness is decreased, and the stripes become inconspicuous. The width of the stripe charging unevenness is about from several tens μm to several hundreds μm. The charge displacement of the charging unevenness of a relatively wide stripe form has a fluctuation range of about ±100 V. The stripe charging unevenness due to the too thick brush fibers is reduced when the monofilament fineness of the brush fibers becomes 9 dtex or less.

However, when the monofilament fineness of the brush fibers is decreased to 9 dtex or less, stripe charging unevenness like fine scratch marks becomes conspicuous instead of the wide stripe charging unevenness. The fine stripe charging unevenness has a width of about from several μm to several tens μm including a number of stripes having a width of several μm. The fine charging unevenness largely forms in an area that is charged at a potential higher than the average potential by about 200 V.

There is such a risk that stripe density unevenness occurs on forming a halftone image due to the charging unevenness even though the surface of the photoreceptor is not scraped in a stripe form. It is considered that this is because a conductive brush having a smaller fineness of brush fibers causes fluctuation in dispersion state of the conductive material, which brings about fluctuation in resistance of the fibers, and abnormal discharge occurs due to the unevenness in dispersion of the conductive material.

In a transfer belt and an intermediate transfer belt used in an image forming apparatus, conductive fine particles containing carbon black having been subjected to an oxidation treatment having high dispersibility are used as a conductive material in some cases. The use of oxidation-treated carbon black can reduce the fluctuation in resistance over the entire belt. For example, oxidation-treated carbon black is dispersed in a belt-form member or a sheet member containing a polyimide resin. The oxidation-treated carbon black has a small electric field dependency and is hard to cause electric field concentration due to transfer voltage. Accordingly, it is used in a transfer belt and an intermediate transfer belt, and is used as a surface layer of a sheet, which is to be wound in a tube form on a charging roller or the like. However, such a conductive brush has not yet been put into practical use that contains oxidation-treated carbon black dispersed in resin fibers.

Accordingly such a conductive brush, a process cartridge and an image forming apparatus are demanded that in a conductive brush used in an image forming apparatus, abnormal discharge due to fluctuation in resistance caused by dispersion unevenness of a conductive material occurring on reducing the thickness of fibers is prevented to obtain a favorable image.

### SUMMARY OF THE INVENTION

An aspect of the invention is that unevenness in resistance of brush fibers caused by dispersion unevenness of a conductive material in a resin is prevented from occurring to realize a favorable image formation process without occurrence of abnormal discharge, whereby a toner image having high image quality without density unevenness can be obtained.

According to an embodiment of the invention, a conductive brush is characterized by containing a substrate and conductive fibers containing conductive carbon black having been subjected to an oxidation treatment dispersed in a resin and being attached in a brush form on the substrate.

### BRIEF DESCRIPTION OF THE DRAWINGS

FIG. 1 is a schematic constitutional view showing a part of a conductive brush according to a first embodiment of the invention;

FIG. 1A is an illustrative view showing the configuration of brush fibers of a conductive brush in a pile form according to the first embodiment of the invention;

FIG. 1B is an illustrative view showing the configuration where tips of the brush fibers shown in FIG. 1A according to the first embodiment of the invention are cut;

FIG. 2A is a schematic cross sectional view showing a brush fiber according to the first embodiment of the invention;

FIG. 2B is a schematic cross sectional view showing a brush fiber having protrusions according to the first embodiment of the invention;

FIG. 2C is a schematic cross sectional view showing a brush fiber having a core/shell structure according to the first embodiment of the invention;

FIG. 2D is a schematic cross sectional view showing a brush fiber having a core/shell structure and protrusions according to the first embodiment of the invention;

FIG. 3 is a schematic constitutional view showing an image forming apparatus according to the first embodiment of the invention;

FIG. 4 is an illustrative view showing schematically evaluation of an image according to the first embodiment of the invention;

FIG. 5 is a graph showing an area ratio of charging unevenness of less than 100 V of a charging brush containing nylon 6 as a resin according to the first embodiment of the invention;

FIG. 6 is a graph showing an area ratio of charging unevenness of 100 V or more of a charging brush containing nylon 6 as a resin according to the first embodiment of the invention;

FIG. 7 is a graph showing an area ratio of charging unevenness of 100 V or more depending on pH of oxidation-treated carbon black of a charging brush containing nylon 6 as a resin according to the first embodiment of the invention;

FIG. 8 is a graph showing an area ratio of charging unevenness of 100 V or more of a charging brush containing polyimide as a resin according to the first embodiment of the invention;

FIG. 9 is a graph showing an area ratio of charging unevenness of 100 V or more of a charging brush containing polyester as a resin according to the first embodiment of the invention;

FIG. 9A is a graph showing an area ratio of charging unevenness of 100 V or more of a charging brush containing rayon as a resin according to the first embodiment of the invention;

FIG. 10A is a schematic constitutional view showing an image forming part according to a second embodiment of the invention;

FIG. 10B is a schematic constitutional view showing the image forming part according to the second embodiment of the invention, where a cleaning device has been detached from the vicinity of a photoreceptor drum;

FIG. 11 is a table for evaluating an occurrence status of charging unevenness upon using a cleaning brush according to the second embodiment of the invention;

FIG. 12 is a flow chart showing control on exchanging a cleaning device according to the second embodiment of the invention;

FIG. 13 is a schematic constitutional view showing an image forming part according to a third embodiment of the invention;

FIG. 14 is a table for evaluating occurrence status pinholes in a photoreceptor drum upon using a disturbing brush according to the third embodiment of the invention;

FIG. 15 is a schematic constitutional view showing an image forming part using a disturbing brush having another configuration according to the third embodiment of the invention;

FIG. 16 is a schematic constitutional view showing an image forming part according to a fourth embodiment of the invention;

FIG. 17 is a table for evaluating scraping of a photoreceptor drum with a cleaning brush according to the fourth embodiment of the invention;

FIG. 18 is a schematic constitutional view showing an image forming part of a cleaner system according to a fifth embodiment of the invention;

FIG. 19A is a schematic constitutional view showing a developing device according to the fifth embodiment of the invention viewed from the direction of an axis of a photoreceptor drum;

FIG. 19B is a schematic constitutional view showing the developing device according to the fifth embodiment of the invention viewed from the front side; and

FIG. 20 a schematic constitutional view showing an image forming part of a cleanerless system according to a fifth embodiment of the invention.

### DETAILED DESCRIPTION OF THE EMBODIMENTS

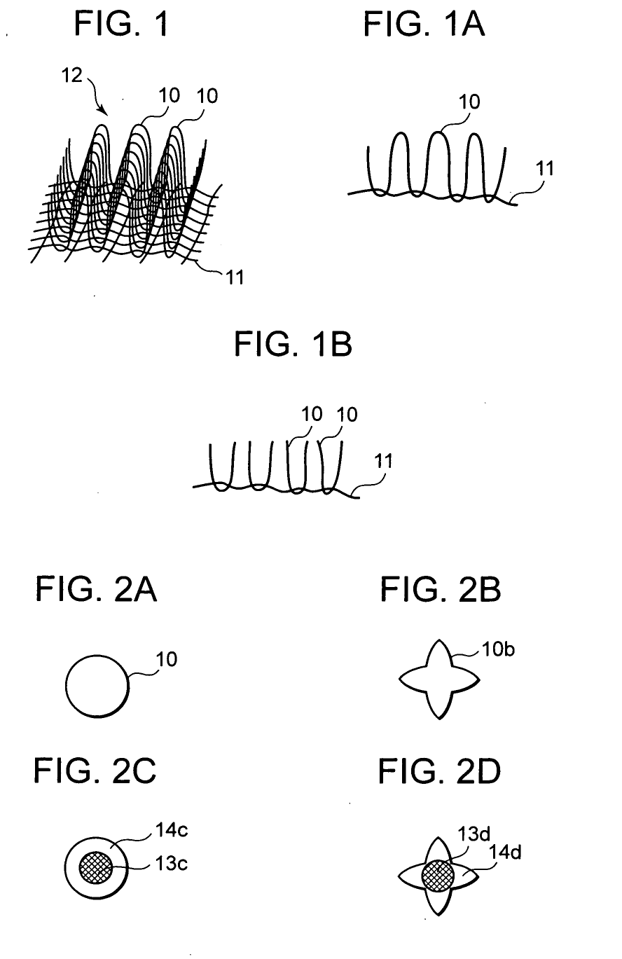

Embodiments of the invention will be described in detail with reference to the attached drawings as examples. FIG. 1 is a schematic constitutional view showing a conductive brush 12 according to the first embodiment of the invention containing conductive brush fibers 10 woven in a pile form on a conductive substrate cloth 11 as a substrate. The brush fibers 10 may be left to be wound on the substrate cloth 11 as shown in FIG. 1A, or the tips of the wound fibers may be cut as shown in FIG. 1B.

The main material of the brush fibers 10 is preferably a polyamide resin having a relatively low water absorption coefficient. According to the material, various mechanical properties are stabilized with respect to fluctuation in resistance due to the environments. Examples thereof include nylon 6, 11, 12 and 66. The conductive material is preferably acidic conductive carbon black of pH 4.5 or less. The acidic conductive carbon black of pH 4.5 or less is produced by subjecting carbon black to an oxidation treatment and is referred to as oxidation-treated carbon black.

The oxidation-treated carbon black of pH 4.5 or less has an oxygen-containing functional group, such as a carboxyl group, a quinone group, a lactone group and a hydroxyl group, on the surface through the oxidation treatment, and is excellent in dispersibility in a resin matrix. The oxidation treatment may be carried out by an air oxidation method of reacting oxidation-treated carbon black by making in contact with the air under a high temperature atmosphere, a method of reacting oxidation-treated carbon black with a nitrogen oxide or ozone at ordinary temperature, a method of air-oxidizing oxidation-treated carbon black at a high temperature and then ozone-oxidizing the oxidation-treated carbon black at a lower temperature, and the like.

The oxidation-treated carbon black can be produced, for example, by a contact method represented by a channel method and a gas black method. After the treatment, the carbon black may be subjected to a liquid phase oxidation treatment with nitric acid or the like depending on necessity.

The oxidation-treated carbon black can also be produced by such a method as a furnace method. In this case, it has been said that carbon black having high pH and a small content of a volatile component can only obtained by a furnace method. Accordingly, the aforementioned liquid phase oxidation treatment is carried out to control the pH. Oxidation-treated carbon black having been controlled in pH to 4.5 or less by the method may also be used as the brush fibers 10 of the embodiment.

The pH value of the oxidation-treated carbon black used in the embodiment is pH 4.5 or less, and more preferably pH 3 or less. The pH value of carbon black is obtained by preparing an aqueous suspension of carbon black and measuring it with a glass electrode. The pH of the oxidation-treated carbon black can also be controlled by the conditions in the oxidation treatment, such as the treating temperature and the treating time.

The oxidation-treated carbon black preferably contains a volatile component in a range of from 1 to 30%. In the case where the volatile component is less than 1%, there are some cases where the effect of the oxygen-containing functional group attached to the surface is lost to lower the dispersibility in the resin matrix. In the case where the volatile component is more than 30%, on the other hand, there are some cases where it is decomposed, or the amount of water adsorbed to the oxygen-containing functional group on the surface is increased, upon dispersing in the resin matrix, whereby the resulting molded article is inferior in appearance. Therefore, the dispersibility in the resin matrix can be improved by making the volatile component in the aforementioned range. The volatile component can be obtained as a ratio of an organic volatile component (such as a carboxyl group, a hydroxyl group, a quinone group and a lactone group) coming out on heating the oxidation-treated carbon black at 950° C. for 7 minutes, based on the total weight thereof before heating.

Specific examples of the oxidation-treated carbon black include MA100S and MA77, all produced by Mitsubishi Chemical Corp., and Printex 150T (pH 4.5), Special Black 350 (pH 3.5) Special Black 100 (pH 3.3), Special Black 250 (pH 3.1), Special Black 5 (pH 3.0), Special Black 4 (pH 3.0), Special Black 4A (pH 3.0), Special Black 550 (pH 2.8), Special Black 6 (pH 2.5), Color Black FW200 (pH 2.5), Color Black FW2 (pH 2.5), Color Black FW2V (pH 2.5), Monarch 1000 (pH 2.5), Monarch 1300 (pH 2.5), Monarch 1400 (pH 2.5), Mogul-L (pH 2.5) and Regal 400R (pH 4.0), all produced by Degussa AG.

The monofilament fineness of the brush fibers 10 used as a charging member is necessarily 9 dtex or less for preventing stripe charging unevenness caused by contact unevenness of the fibers from being conspicuous. The monofilament fineness of the brush fibers 10 is preferably 6 dtex or less. In the case where it is less than 0.5 dtex, however, the brush fibers 10 are liable to be broken, and a preferred range thereof is from 0.5 to 6 dtex. In the case where the brush is used for cleaning, disturbing of a toner image or electric eraser, the monofilament fineness of the brush fibers 10 may be 9 dtex or more, but is preferably 9 dtex or less from the standpoint of stability in performance.

The conductive material is uniformly dispersed inside and outside the brush fibers 10 of the embodiment. Accordingly, both embodiments may be employed, in which tips of the brush fibers in a pile form are cut to make the cross section of brush into contact with a photoreceptor as shown in FIG. 1B, and the brush fibers 10 are formed into a loop form to make an outer surface of the fibers in a pile form into contact with a photoreceptor as shown in FIG. 1A.

In the case where conduction to the substrate cloth 11 or a support thereof is obtained on applying a voltage to the brush fibers 10, the fibers may be implanted by an electrostatic measure, in addition to the method of weaving the fibers into the substrate cloth 11 as shown in FIG. 1. It is preferred that the fibers are woven by pile weaving from the standpoint of adhesion strength between the substrate cloth 11 and the brush fibers 10.

The brush fibers 10 of the embodiment have such a constitution that the fibers contain oxidation-treated carbon black of pH 4.5 or less uniformly dispersed in a fiber resin, such as nylon, and have a substantially circular cross section as shown in FIG. 2A. However, the constitution of the brush fibers is not limited thereto. For example, even in the fibers containing oxidation-treated carbon black uniformly dispersed, such brush fibers 10b may be used that have protrusions on the cross section thereof as shown in FIG. 2B. The charging unevenness can be reduced theoretically when the brush fibers are thin. Therefore, the brush fibers 10b can provide characteristics of a brush having a smaller diameter by utilizing the protrusions as thin fibers. The brush fibers are liable to be broken to deteriorate the durability thereof when the brush fibers are too thin, but the brush fibers 10b having protrusions are hard to be broken since the fibers themselves are thick, and thus high durability is expected.

As the structure of the brush fibers, a multifilament structure may also be used in addition to the uniformly dispersed structure. The multifilament structure can be obtained in such a manner that upon stretching and molding after dispersing oxidation-treated carbon black in a fiber resin, multi-filaments formed of materials having different compositions are stretched and combined with each other.

In other words, fibers having different compositions are adhered to each other. Examples of the structure include core/shell composite structures shown in FIGS. 2C and 2D. For example, a core part 13c or 13d of the fibers is formed of a resin containing no oxidation-treated carbon black or has a small amount of oxidation-treated carbon black, whereby the durability thereof is improved. The outer part 14c or 14d of the fibers contains a large amount of oxidation-treated carbon black dispersed therein for controlling the conductivity. The composite structure having the core/shell structure, in which a nonconductive component or a weakly conductive component is encompassed with a conductive component, enables both durability and conductivity of the brush fibers.

In the embodiment, conductivity is obtained by dispersing the oxidation-treated carbon black in a fiber resin, and the oxidation-treated carbon black is not particularly improved in durability as compared to conventional carbon black. However, in the case where the brush fibers 10 have the core/shell structure, the brush fibers 10 have high durability since the brush fibers 10 themselves do not become brittle even though the dispersed amount of the oxidation-treated carbon black is increased for decreasing the resistance.

The brush fibers 10 may further contain inorganic fine particles in addition to the oxidation-treated carbon black. Examples of the inorganic fine particles include titanium dioxide and cerium oxide. The brush fibers 10 having the inorganic fine particles dispersed therein can scrape the surface of the photoreceptor sensitively and uniformly. Accordingly, by making a conductive brush 12 containing the brush fibers 10 into slidingly contact with the photoreceptor, filming on the photoreceptor can be prevented from occurring.

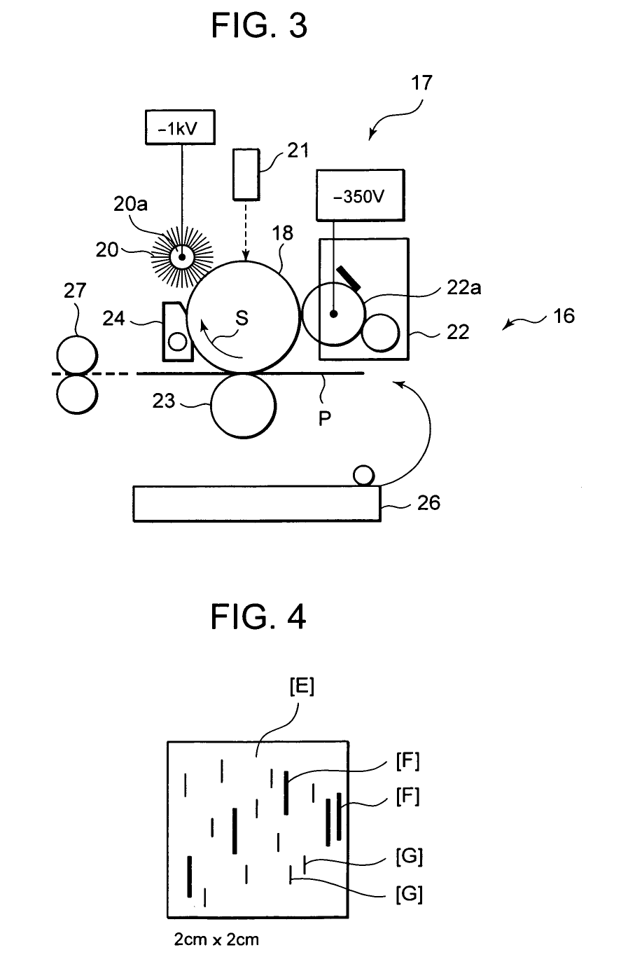

The case where the conductive brush 12 is used as a charging member of an image forming apparatus of an electrophotographic system will be described. FIG. 3 is a schematic constitutional view showing an image forming part 17 of an image forming apparatus 16 having the conductive brush as a charging member. A charging brush 20 as a charging member, a laser exposing device 21, a developing device 22, a transfer roller 23 and a cleaning device 24 are sequentially disposed around a photoreceptor drum 18 as an image carrying member along the rotation direction shown by the arrow S. The charging brush 20 is applied with a bias of −1 kV, and a developing roller 22a of the developing device 22 is applied with a bias of −350 kV. Both the members may be applied with an alternating electric field. For example, an alternating current having peak-to-peak (PP) of from 2 to 8 kV and from 500 Hz to 500 kHz may be applied.

In the image forming part 17, the photoreceptor drum 18 is rotated in the direction shown by the arrow S upon starting the image formation process. The photoreceptor drum 18 is thus charged uniformly with the charging brush 20. The photoreceptor drum 18 is then irradiated with laser light corresponding to image data with the laser exposing device 21 to form an electrostatic latent image. The photoreceptor drum 18 is then developed with the developing device 22 and transfers a toner image at the position of the transfer roller 23 to sheet paper P fed from paper feeding part 26. The sheet paper P is then released from the photoreceptor drum 18, and the toner image is fixed with a fixing device 27. Separately, the photoreceptor drum 18 after transferring the toner image is cleaned for removing the residual toner with the cleaning device 24 to prepare for the next image formation process.

The charging brush 20 will be described in detail. The charging brush 20 is prepared by adhering a conductive brush 12, which is prepared by weaving the brush fibers 10 in a conductive substrate cloth 11, to a metallic shaft 20a having a diameter of 8 mm. The tips of the brush fibers 10 are cut under rotation of the metallic shaft 20a to obtain a brush having a diameter of 18 mm in a pile form having cut tips. The substrate cloth 11 has a thickness of 0.5 mm, and thus the fiber length of the brush fibers 10 is 4.5 mm.

Determination of charging unevenness upon charging the photoreceptor drum 18 by using the charging brush 20 will be described. In order to evaluate charging unevenness, a phthalocyanine organic photoreceptor having a diameter of 60 mm was used as the photoreceptor drum 18. The charging brush 20 was made in contact with the photoreceptor drum 18 with an overlapping amount of 0.5 mm, and was rotated in the same direction as the photoreceptor drum 18 shown by the arrow t at a twofold speed difference. The bias application to the charging brush 20 is effected by applying a voltage to the metallic shaft 20a. In the experiment, a DC bias was applied. The charging potential was measured with a Monroe surface potentiometer.

Charging unevenness cannot be measured with a surface potentiometer for evaluation due to the fineness of charging unevenness. Accordingly, one-component development was effected by making a developing roller containing a toner having been charged by friction into contact with the photoreceptor drum 18, and the image density on the surface of the photoreceptor drum 18 was measured to evaluate the charging unevenness.

The charging unevenness due to the charging brush 20 increases the surface potential (in the negative direction) in most cases upon applying a DC bias to the charging brush 20, and appears as white stripes on the image. This is formed because when the photoreceptor drum 18 is once excessively charged exceeding the normal discharge phenomenon due to abnormal discharge or charge injection, it is not electric erased during passage through the position of the charging brush 20. In the area where the charging brush 20 is insufficiently charged, on the other hand, the photoreceptor drum 18 has plural occasions of making in contact with the brush fibers 10 during passage through the position of the charging brush 20. Thus, the photoreceptor drum 18 is charged in plural times during passage through the position of the charging brush 20, and thus the most parts thereof are charged to the normal potential finally. The charging unevenness where the surface potential is increased is roughly classified into fine sharp white stripes and wide weak stripes with a relatively large width.

The measurement method of charging unevenness will be specifically described. The photoreceptor drum 18 charged on the surface thereof to an average voltage of −300 V with the charging brush 20 is developed with a developing roller biased to −400 V to obtain a halftone image. At this time, the most parts of the surface of the photoreceptor drum 18 are developed to provide a reflective density of about 1.0. In an area having a high surface potential by about 100 V (−400 V) due to excessive charging, the reflective density is lowered to about 0.2. An area with a further higher surface potential is not developed to form white dropout.

The halftone image is then trinarized, and divided into an area having a reflective density of 0.9 or more, which is normally charged, an area having a reflective density of from 0.2 to 0.9, which is highly charged until about 100 V, and an area having a reflective density of 0.2 or less, which is charged 100 V or more. The area ratios of the three areas are measured. The image is magnified with a microscope, and an area of 2 cm×2 cm is measured with a resolution of 1 μm. FIG. 4 schematically shows the evaluation of an image. An area shown by [E] in FIG. 4 is the area having a reflective density of 0.9 or more, which is normally charged, an area shown by [F] is the area having a reflective density of from 0.2 to 0.9, which is highly charged until about 100 V, and an area shown by [G] is the area having a reflective density of 0.2 or less, which is charged 100 V or more.

The charging unevenness occurring on the photoreceptor drum 18 due to the charging brushes 20 formed of various kinds of brush fibers was evaluated in the aforementioned manner. A charging brush having oxidation-treated carbon black having pH 2.6 (MA77, produced by Mitsubishi Chemical Corp.) dispersed therein, and as a comparative example, a charging brush having conventional carbon black having pH 7.8 (furnace black) dispersed therein were used.

Nylon 6 as a polyamide resin, a polyimide resin, a polyester resin and a rayon resin were used as the resin of the brush fibers 10. The production method of the fibers may be arbitrarily determined, and for example, polyimide fibers are formed by a melt spinning method, in which a resin melted at high temperature is extruded from nozzles and taken up by using Capirograph IC, produced by Toyo Seiki Kogyo Co., Ltd. At this time, the conditions are changed to produce specimens having several kinds of finenesses. The amount of carbon dispersed is from 10 to 40 parts by weight and is controlled, whereby the resistance of the brush is from 1×10⁵ to 1×10⁶Ω. As a charging brush, a brush having a resistance of from 1×10⁴ to 1×10⁹Ω can be used. The measurement of the resistance of the charging brush is effected in such a manner that the charging brush is made in contact with an aluminum raw tube with an overlapping amount of about 0.5 mm, and an electric current flowing in the aluminum raw tube is measured under application of 1,000 V to the charging brush. The circumferential velocity of the charging brush upon measurement is in the same direction as the aluminum raw tube at a twofold speed difference as similar to that in the image formation process.

### Evaluation 1

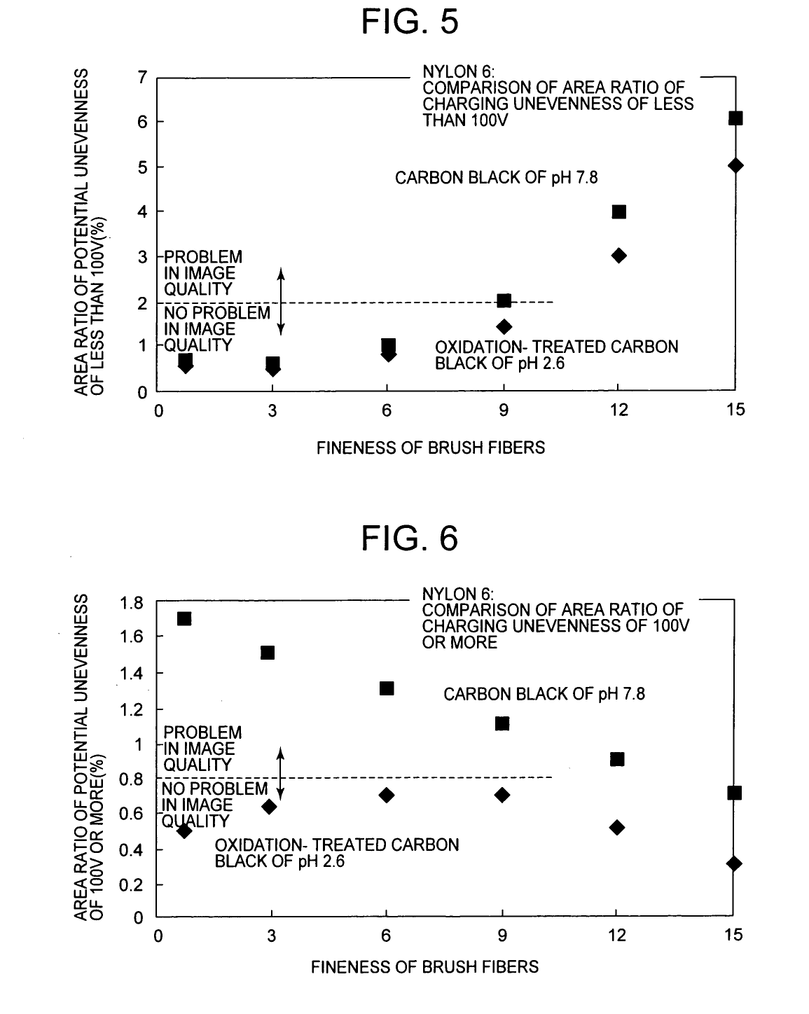

The charging unevenness was evaluated by using nylon 6 as the resin of the charging brush. The area ratio of the charging unevenness of less than 100 V was measured with variation in fineness of the brush fibers. The measurement results are shown in FIG. 5. Substantially no problem occurs in image quality when the area ratio of the charging unevenness of less than 100 V is less than 2% upon determining visually the halftone image.

It was found from FIG. 5 that when the fineness of the charging brush was 9 dtex or less, white stripes of less than 100 V was less than 2% in both the brush having the oxidation-treated carbon black of pH 2.6 dispersed therein as a conductive material and the brush having the carbon black of pH 7.8 dispersed therein, so as to cause substantially no problem. It was understood however that when the oxidation-treated carbon black was used, the area of white stripes of less than 100 V could be reduced even though only slightly.

The area ratio of the charging unevenness of 100 V or more was then measured with variation in fineness of the brush fibers of nylon 6. The measurement results are shown in FIG. 6. Substantially no problem occurs in image quality when the area ratio of the charging unevenness of 100 V or more is less than 0.8% upon determining visually the halftone image.

It was found from FIG. 6 that with the conventional brush having the carbon black of pH 7.8 dispersed therein, there was such a tendency that the charging unevenness of 100 V or more was increased when the fineness was increased. As a result, in the conventional conductive brush, it was understood from FIG. 5 that substantially no problem occurs in charging unevenness of less than 100 V with a fineness of 9 dtex or less, but it was understood from FIG. 6 that the area ratio of white stripes due to the charging unevenness of 100 V or more became 1.0% or more at that fineness to provide a problem in image quality.

On the other hand, with the conductive brush of the embodiment having the oxidation-treated carbon black of pH 2.6 dispersed therein, the charging unevenness was substantially not increased when the fineness was decreased beyond 9 dtex, and upon further thinning the fibers, the charging unevenness was further decreased. This is because by using the oxidation-treated carbon black having good dispersibility, the resistance of the brush fibers was not fluctuated but was uniform over the entire length of the fibers particularly in the charging brush having a small fineness of 9 dtex or less. As a result, the charging unevenness of a potential difference of 100 V or more due to abnormal discharge on charging was suppressed from being increased. Accordingly, it was found as apparent from FIG. 6 that in the conductive brush of the embodiment, the area ratio of white stripes due to the charging unevenness of 100 V or more could be maintained at less than 0.8 even with the thin fineness of 9 dtex or less to provide substantially no problem in image quality.

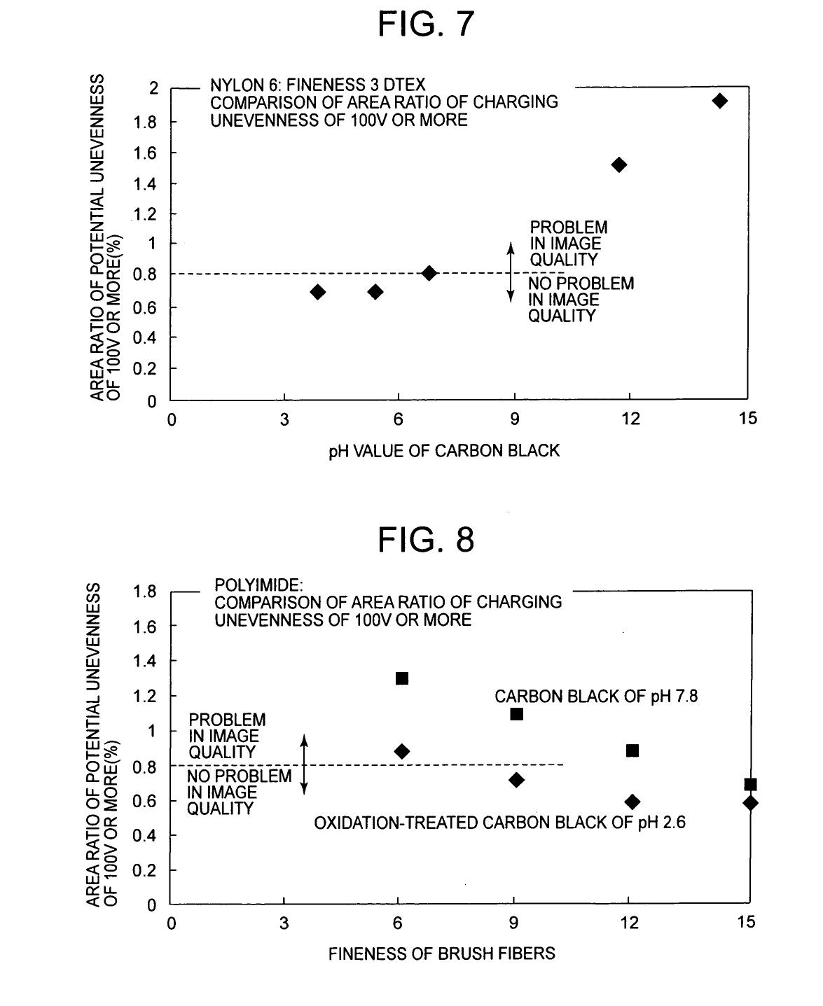

Furthermore, the relationship between the pH value of the oxidation-treated carbon black and the area ratio of the charging unevenness was measured with nylon 6. The area ratio of the charging unevenness was measured while the pH value of the oxidation-treated carbon black was changed from pH 2.5 to pH 9.5 with a fineness of the brush fibers of 3 dtex. As shown in FIG. 7 showing the results, it was found that the oxidation-treated carbon black having pH 4.5 or less provided good dispersibility and an area ratio of the charging unevenness of 100 V or more became less than 0.8, and thus it could be used as a charging brush.

### Evaluation 2

The charging unevenness was evaluated by using a resin containing polyimide as a major component as a resin of the charging brush. The area ratio of the charging unevenness of 100 V or more was measured with variation in fineness of the brush fibers. The measurement results are shown in FIG. 8. In the case where polyimide was used as a major component, no brush could be produced with fibers of 3 dtex or less due to brittleness. Accordingly, the area ratio of the charging unevenness was measured with a fineness in a range of from 6 to 15 dtex, which was prepared.

As shown in FIG. 8, the area ratio of the charging unevenness of the conductive brush of the embodiment having the oxidation-treated carbon black of pH 2.6 dispersed therein was decreased as compared to the conventional conductive brush having carbon black of pH 7.8 dispersed therein. There was no large difference from the conventional conductive brush in the case where the fineness was as large as 15 dtex, but when the fineness was decreased, the difference was increased. In the case of a polyimide resin, however, no peak was found in charging unevenness when the fineness was decreased. In the case of the polyimide resin, the charging unevenness was gradually increased with thinning the fineness even in the brush of the embodiment. As a result, the area ratio of the charging unevenness exceeded 0.8% at a fineness of 6 dtex to provide a problem in image quality.

### Evaluation 3

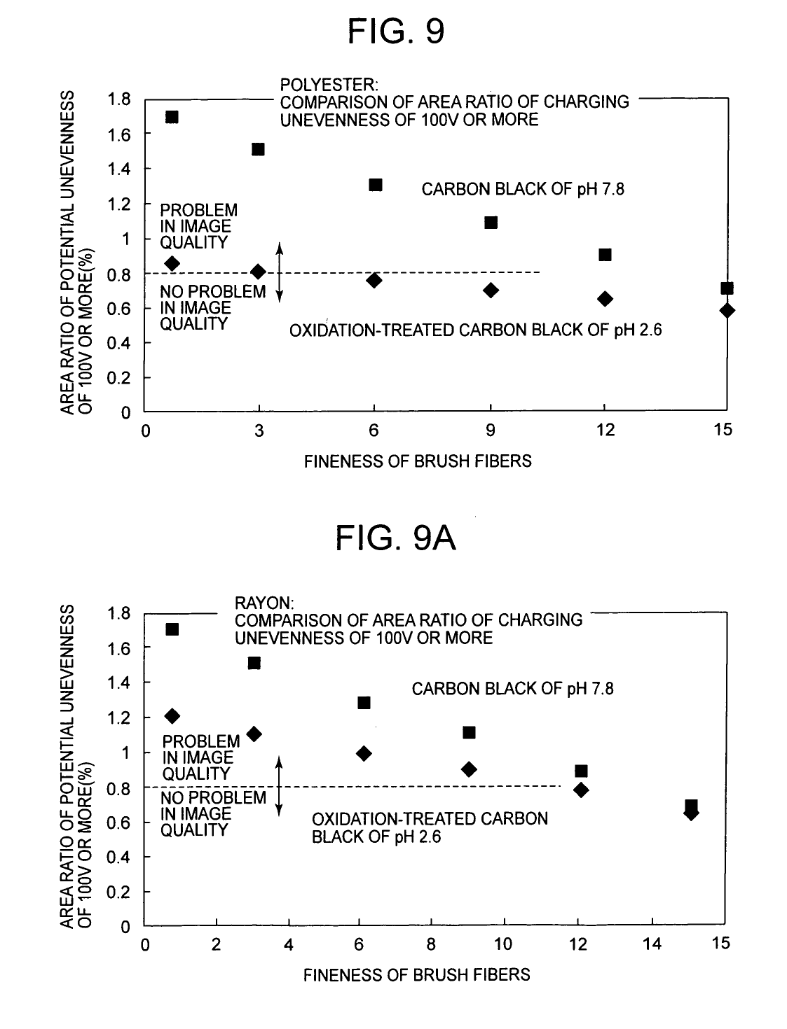

The charging unevenness was evaluated by using a resin containing a polyester resin as a major component as a resin of the charging brush. Fibers having different finenesses were produced with the polyester resin by a melt spinning method having been well known in the art. Fibers having a fineness of 3 dtex or less could be produced with the polyester resin. As shown in FIG. 9, the area ratio of the charging unevenness of the conductive brush of the embodiment having the oxidation-treated carbon black of pH 2.6 dispersed therein was decreased as compared to the conventional conductive brush having carbon black of pH 7.8 dispersed therein.

There was no large difference of the area ratio of the charging unevenness between the conductive brush of the embodiment and the conventional conductive brush in the case where the fineness was as large as 15 dtex. However, when the fineness was decreased, the effect obtained by using the oxidation-treated carbon black having good dispersibility was exerted. When the fineness was decreased, the difference between the conventional brush and the brush of the embodiment was increased. In the case of the polyester resin, however, the charging unevenness was gradually increased with thinning the fineness even in the brush of the embodiment. As a result, the area ratio of the charging unevenness exceeded 0.8 at a fineness of 3 dtex to provide a problem in image quality.

### Evaluation 4

The charging unevenness was evaluated by using a resin containing a rayon resin as a major component as a resin of the charging brush. Fibers having different finenesses were produced with the rayon resin by a melt spinning method having been well known in the art. Fibers having a fineness of 3 dtex or less could be produced with the rayon resin. As shown in FIG. 9A, the area ratio of the charging unevenness of the conductive brush of the embodiment having the oxidation-treated carbon black of pH 2.6 dispersed therein was decreased as compared to the conventional conductive brush having carbon black of pH 7.8 dispersed therein. In the case of the rayon resin, however, the charging unevenness was gradually increased with thinning the fineness even in the brush of the embodiment. Furthermore, the total effect obtained by using the oxidation-treated carbon black was small as compared to the other fibers. As a result, the area ratio of the charging unevenness exceeded 0.8% at a fineness of 12 dtex or less to provide a problem in image quality.

According to the first embodiment, the oxidation-treated carbon black having good dispersibility is dispersed in a fiber resin to produce conductive brush fibers 10. Accordingly, a conductive brush 12 having substantially uniform resistance over the entire length can be obtained with the thin brush fibers 10 having a fineness of 15 dtex or less.

In the case where the conductive brush 12 is used as a charging brush 20 in an image forming apparatus 16, scraping in a stripe form of the surface of a photoreceptor drum 18 due to thick brush fibers 10 can be prevented from occurring since the fineness of the brush fibers 10 can be decreased, and thus charging unevenness in a stripe form of less than 100 V can be prevented from occurring. Furthermore, abnormal discharge due to unevenness in resistance of the brush fibers 10 can be prevented from being increased even when the fineness of the brush fibers 10 is decreased, and thus charging unevenness in a sharp stripe form of 100 V or more can be prevented from being increased. Particularly, in the case where the oxidation-treated carbon black is dispersed in nylon as a polyamide resin, such a significant effect can be obtained that the charging unevenness can be prevented from being increased in a particularly thin fineness range of 9 dtex or less. Accordingly, both the charging unevenness due to damages in a stripe form on the photoreceptor drum 18 and the sharp charging unevenness due to abnormal discharge are prevented from occurring to obtain a favorable image.

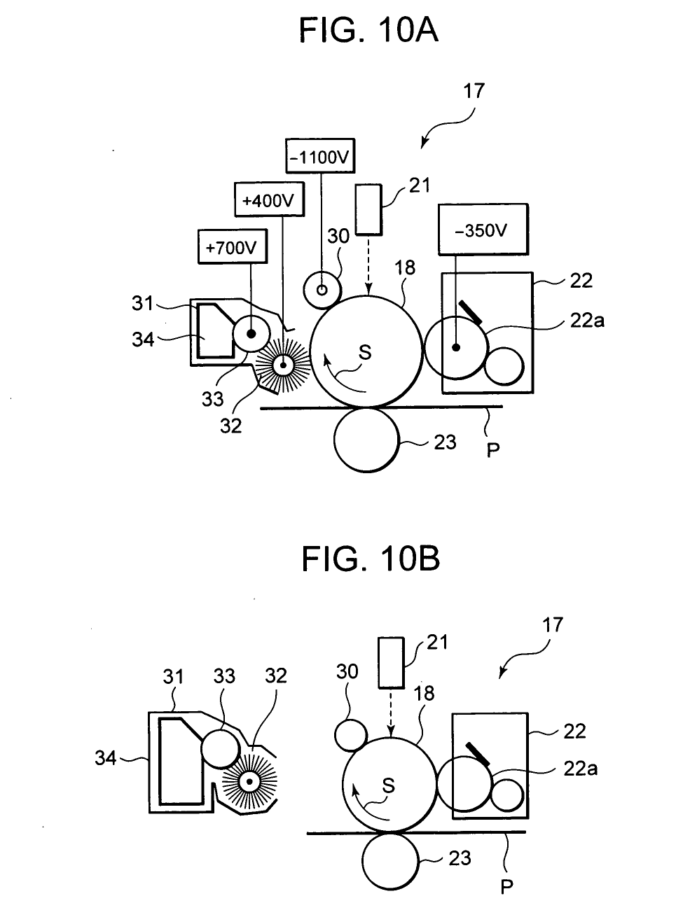

A second embodiment of the invention will be described. The second embodiment uses the conductive brush of the first embodiment as a cleaning member of an image forming apparatus of an electrophotographic system. In the second embodiment, therefore, the same constitutions as described in the first embodiment are attached with the same symbols for omitting the detailed descriptions thereof. FIG. 10A is a schematic constitutional view showing an image forming part 17 of an image forming apparatus 16 having the conductive brush 10 installed therein as a cleaning member. A charging roller 30, a laser exposing device 21, a developing device 22, a transfer roller 23 and a cleaning device 31 are sequentially disposed around a photoreceptor drum 18 along the rotation direction shown by the arrow S.

The cleaning device 31 is the cleaning member and has a cleaning brush 32 in sliding contact with the photoreceptor drum 18, a removal roller 33 removing a toner recovered with the cleaning brush 32, and a waste toner reservoir 34. The cleaning brush 32, the removal roller 33 and the waste toner reservoir 34 are unitized to form the cleaning device 31. The cleaning device 31 is unitized, and as shown in FIG. 10B, the cleaning brush 32, the removal roller 33 and the waste toner reservoir 34 can be detached as a unit from the vicinity of a photoreceptor drum 18.

The overlapping amount of the cleaning brush 32 and the photoreceptor drum 18 may be such an amount that both the members are in contact with each other and is preferably about from 0.1 to 2 mm. In order to ensure the overlapping amount, for example, such a constitution can be considered that guide rings are provided on both ends of the cleaning brush 32, which is pressed onto the photoreceptor drum 18. However, since the overlapping amount has a large tolerance, sufficient performance can be obtained by positioning them, for example, with a chassis supporting the photoreceptor drum 18 and the unit main body of the cleaning device 31.

In the image forming part 17, the charging roller 30 is applied with 1,100 V upon starting the image forming process, and the surface of the photoreceptor drum 18 rotated in the direction shown by the arrow S is charged to about −500 V. Subsequently, exposure corresponding to a print ratio of 10% is effected with the laser exposing device 21, then reversal development is effected with a toner having a negative polarity by using a developing roller 22a of the developing device 22 applied with a bias of −350 V, and then a toner image is transferred to sheet paper P at the position of the transfer roller 23. Thereafter, the residual toner remaining on the photoreceptor drum 18 after transferring is cleaned with the cleaning brush 32.

The cleaning brush 32 is applied with +400 V to effect bias cleaning of the residual toner charged negatively on the photoreceptor drum 18. The residual toner thus recovered with the cleaning brush 32 is eliminated in bias with the removal roller 33 applied with a bias voltage of +700 V and recovered to the waste toner reservoir 34.

In the bias cleaning with the cleaning brush 32, if the brush fibers of the cleaning brush 32 have fluctuation in resistance, the cleaning brush 32 suffers abnormal discharge or injects charge to the residual toner on the photoreceptor drum 18. In the case where the polarity of the residual toner is inverted to a positive polarity by the abnormal discharge and the charge injection of the cleaning brush 32, the toner once recovered to the cleaning brush 32 is again attached onto the photoreceptor drum 18 and is further attached electrostatically to the contact type charging roller 30. When the amount of the toner attached to the contact type charging roller 30 is increased, charging unevenness occurs upon charging the photoreceptor drum with the charging roller 30, and thus the phenomenon should be prevented from occurring.

In the case where the conductive brush 12 formed of the brush fibers 10 having the oxidation-treated carbon black having good dispersibility dispersed therein is used as the cleaning brush 32, the resistance of the brush fibers 10 is substantially uniform over the entire length thereof even though the fineness of the brush fibers 10 is decreased to 15 dtex or less. Accordingly, the cleaning brush 32 can prevent the abnormal discharge and the charge injection to the toner upon cleaning from occurring. Therefore, the re-attachment of the toner from the cleaning brush 32 to the photoreceptor 18 caused by the inverse charging of the toner can be prevented from occurring, whereby the toner can be prevented from being attached to the charging roller 30.

A comparative experiment was carried out for determining a number of sheet of continuous printing until charging unevenness occurred due to attachment of a toner to the charging roller 30 for every cleaning brush. Nylon 6 was used as the fiber resin of the cleaning brush. The pH value of carbon black dispersed in the fiber resin was pH 2.6, pH 4.5 and pH 7.8, and the fineness of the brush fibers was 6 dtex, 9 dtex and 12 dtex. The measurement of charging unevenness was effected in such a manner that upon printing a halftone image having an ID (image density) of about 0.5, it was determined that a problem occurred when a part having density unevenness with ΔID (fluctuation in image density) of 0.1 or more exceeded 5% of the whole.

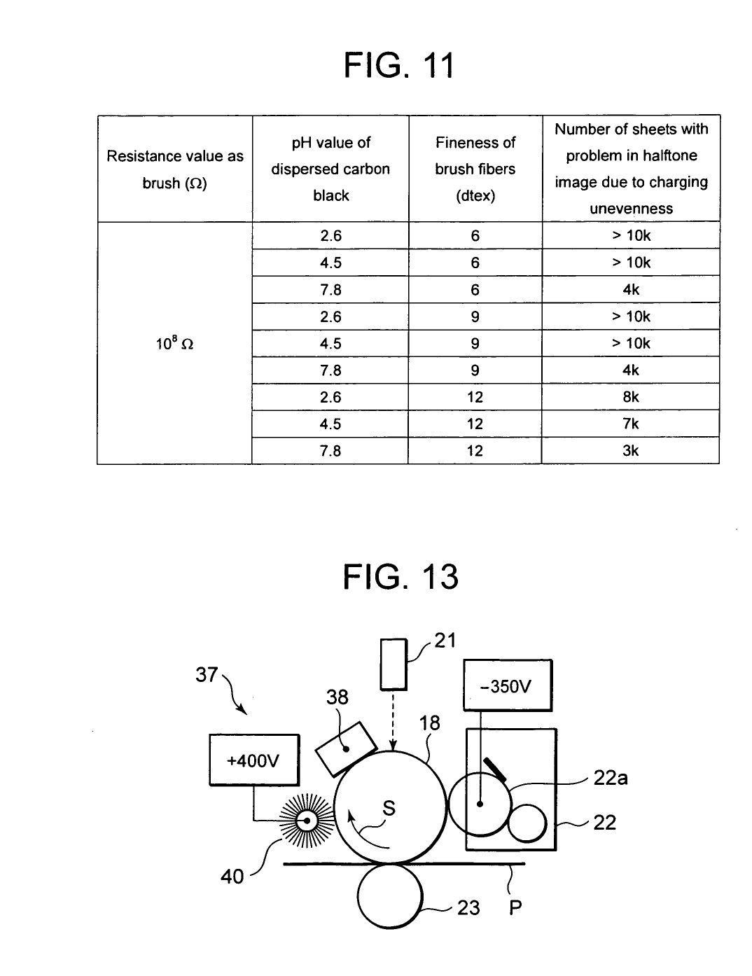

The results are shown in FIG. 11. As a result, in the case where the cleaning brush of the embodiment having the oxidation-treated carbon black of pH 2.6 or pH 4.5 dispersed therein was used, no image defect due to charging unevenness occurred even after printing 10,000 sheets with a fineness of 9 dtex or less. On the other hand, in the case where the conventional cleaning brush having the carbon black of pH 7.8 dispersed therein was used, an image defect due to contamination of the charging roller 30 occurred after continuous printing of from 3,000 to 4,000 sheets irrespective to the fineness of the brush fibers. This showed that the abnormal discharge and the charge injection could be considerably prevented from occurring even with thin fibers of 9 dtex or less, as similar to the case where the brush was used as the charging brush 20 in the first embodiment. It was also shown that a high cleaning effect was obtained with the thick fibers having a fineness of 9 dtex or more as compared to the conventional cleaning brush.

In the case where the waste toner reservoir 34 of the cleaning device 31 is filled to capacity while the residual toner on the photoreceptor drum 18 is removed with the cleaning brush 32 of the embodiment, the unitized cleaning device 31 is detached as a unit from the image forming apparatus 16 as shown in FIG. 10B, and is exchanged by a new cleaning device.

Upon detaching the cleaning device 31 from the photoreceptor drum 18 for exchanging the cleaning device 31, there is such a possibility that the toner accumulated on the cleaning brush 32 spills out to the surroundings. Accordingly, before detaching the cleaning device 31 from the photoreceptor drum 18, the toner accumulated on the cleaning brush 32 is attached to the photoreceptor drum 18 or is recovered to the waste toner reservoir 34, whereby the toner is prevented from spilling out.

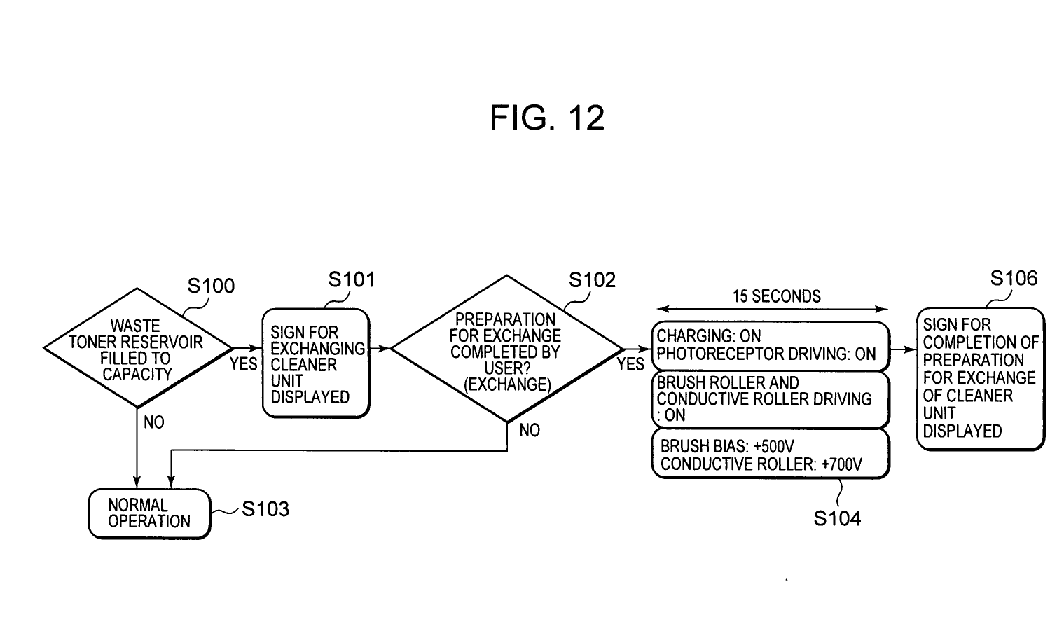

The recovery of the toner on the cleaning brush 32 before exchanging the cleaning device 31 will be described with reference to the flow chart shown in FIG. 12. In step 100, it is determined as to whether or not the waste toner reservoir 34 is filled to capacity. In the case where the waste toner reservoir 34 is not filled to capacity, the normal operation is carried out (step 103). In the case where the waste toner reservoir 34 is filled to capacity, such a sign is displayed on a control panel or the like that the cleaning device 31 should be exchanged, in step 101. In step 102, it is confirmed as to whether or not a user has prepared a new cleaning device 31 for exchange. In the case where no cleaning device 31 for exchange has been prepared, the normal operation in step 103 is carried out. In the case where a cleaning device 31 for exchange has been prepared, the toner on the cleaning brush 32 is removed for 15 seconds in step 104 for preventing the toner from spilling out upon exchanging.

In step 104, the photoreceptor drum 18, the charging roller 30, the cleaning brush 32 and the removal roller 33 are driven for 15 seconds in a state where no image is printed. During the period, the cleaning brush 32 is applied with a bias of 500 V, and the removal roller is applied with a bias of 700 V. According to the operation, the negatively charged toner accumulated on the cleaning brush 32 is moved to the waste toner reservoir. On the other hand, the positively charged toner, which is present on the cleaning brush 32 in a slight amount, is moved to the photoreceptor drum. As a result, the toner on the cleaning brush 32 is sufficiently removed during the period of 15 seconds.

In step 104, the bias applied to the cleaning brush 32 or the removal roller may be changed as compared to the normal image formation process, so as to remove the toner on the cleaning brush 32 in a shorter period of time. Alternatively, in order to improve the recovery efficiency of the toner on the cleaning brush 32, the potential difference between the cleaning brush 32 and the removal roller 33 may be increased as compared to the case of printing an image, and a vibrating electric field, such as an AC bias, may be applied to the removal roller 33. For example, in the case where the bias on the cleaning brush 32 is +400 V in step 104, the bias on the removal roller 33 is about +1,000 V, or an AC bias containing DC +800 V and AC pp 1,500 V with about 500 Hz is applied to the removal roller 33, whereby the capability of toner removal of the removal roller 33 can be improved.

Subsequently, after lapsing 15 seconds in step 104, the operation proceeds to step 106, and such a sign is displayed on a control panel or the like that the preparation for exchanging the cleaning device 31 has been completed. Thereafter, the user exchanges the unitized cleaning device 31.

According to the second embodiment, the conductive brush 12 formed of the brush fibers 10, which has a substantially uniform resistance by dispersing the oxidation-treated carbon black having good dispersibility in a fiber resin, is used as the cleaning brush 32. According to the constitution, the abnormal discharge and the charge injection to the toner of the cleaning brush 32 can be suppressed. Therefore, the re-attachment of the toner to the photoreceptor drum 18 due to inverse charging of the toner can be prevented from being increased, and the amount of the toner attached to the charging roller 30 is prevented from being increased, whereby the charging unevenness on the photoreceptor drum 18 is prevented from being increased.

The cleaning device for recovering the residual toner remaining on the photoreceptor drum 18 after transferring is not limited to the aforementioned constitution. For example, it is possible that the residual toner on the photoreceptor drum 18 is once recovered to a cleaning brush and then again attached to the photoreceptor drum 18 from the cleaning brush during a period where no image is printed, and thereafter, the toner is recovered to the developing device. In this case, by using the cleaning brush of the embodiment having the oxidation-treated carbon black dispersed therein, the abnormal discharge and the charge injection to the toner upon cleaning are suppressed. According to the constitution, such a phenomenon can be suppressed that the toner is inversely charged upon cleaning and again attached to the photoreceptor drum.

Particularly, in the cleaning device, the residual toner is retained after recovering to the cleaning brush. Therefore, such a possibility that the polarity of the toner is inverted during the period where the toner is retained is increased as compared to the cleaning brush shown in FIG. 10. The cleaning brush of the embodiment capable of suppressing the abnormal discharge and the charge injection to the toner can surely prevent the reverse charging of the toner. As a result, attachment of the toner to the charging roller is suppressed to prevent the charging unevenness from being increased.

A third embodiment of the invention will be described. In the third embodiment, the conductive brush of the first embodiment is used as a disturbing member of an image forming apparatus of a cleanerless system. In the third embodiment, therefore, the same constitutions as described in the first embodiment are attached with the same symbols for omitting the detailed descriptions thereof. FIG. 13 is a schematic constitutional view showing an image forming part 37 of an image forming apparatus of a cleanerless system having the conductive brush 10 installed as a disturbing member. A scorotron charger 38, a laser exposing device 21, a developing device 22 having a developing roller 22a applied with a bias of −350 V, a transfer roller 23 and a disturbing brush 40 applied with a bias of +400 V are sequentially disposed around a photoreceptor drum 18 along the rotation direction shown by the arrow S.

The cleanerless process is such a process that instead of a cleaning device for removing a residual toner remaining on the photoreceptor drum 18 after transferring, a pattern of the residual toner is disturbed with a disturbing means and then passed through the exposing position in the next image formation, whereby the residual toner is recovered with the developing device 22. A brush device is often used as the disturbing means.

The disturbing brush 40 once recovers the residual toner on the photoreceptor drum 18 and then gradually returns the toner to the photoreceptor drum 18 with inverting the polarity of the toner by charge injection or the like. Accordingly, the resistance of the disturbing brush 40 is preferably less than 10⁸Ω. However, the resistance of the disturbing brush 40 is decreased excessively, there is such a possibility that abnormal discharge occurs on the photoreceptor drum 18 to form pinholes on the surface of the photoreceptor drum.

A comparative experiment was carried out for determining a number of sheets of continuous printing until various kinds of disturbing brushes form pinholes on the photoreceptor drum 18 to form defects on an image. Nylon 6 was used as the fiber resin of the cleaning brush. The pH value of carbon black dispersed in the fiber resin was pH 2.6, pH 4.5 and pH 7.8, the fineness of the brush fibers was 6 dtex, 9 dtex and 12 dtex, and the resistance of the disturbing brush was 10⁶ and 10⁴Ω.

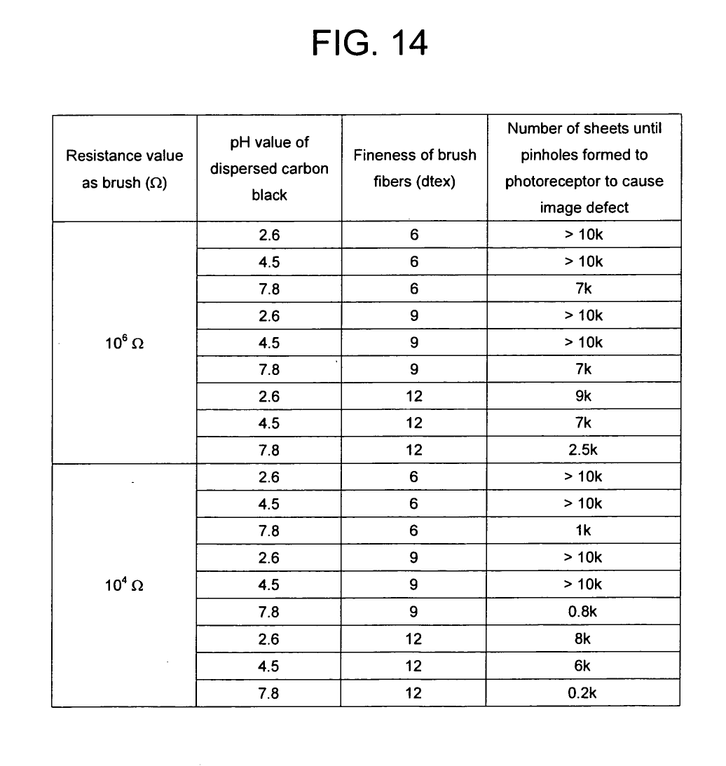

The results are shown in FIG. 14. As a result, in the case where the brush resistance was 10⁶Ω, no pinhole was formed after printing 10,000 sheets with the disturbing brush of the embodiment having the oxidation-treated carbon black of pH 4.5 or less dispersed therein with a fineness of 9 dtex or less. On the other hand, with the conventional disturbing brush having the carbon black of pH 7.8 dispersed therein, an image defect due to pinholes occurred around 7,000 sheets even with a large fineness of 12 dtex. Furthermore, at a brush resistance of about 10⁴Ω, the difference in pH of the carbon black exerted considerable influence. With the disturbing brush of the embodiment using the oxidation-treated carbon black of pH 4.5 or less, no pinhole was formed after printing 10,000 sheets with a fineness of 9 dtex or less. On the other hand, with the conventional disturbing brush using the carbon black of pH 7.8, pinholes were formed around 800 sheets.

It is found that with the conventional disturbing brush, pinholes are liable to form in the photoreceptor drum 18 in a region where the resistance of the brush fibers 10 is low, but with the disturbing brush of the embodiment using the oxidation-treated carbon black, the abnormal discharge is hard to occur.

According to the third embodiment, the conductive brush 12 formed of the brush fibers 10, which has a substantially uniform resistance by dispersing the oxidation-treated carbon black having good dispersibility in a fiber resin, is used as the disturbing brush 40. According to the constitution, the abnormal discharge of the disturbing brush 40 can be suppressed. Therefore, pinholes formed on the photoreceptor drum 18 due to abnormal discharge can be prevented from occurring, and an image defect due to the pinholes can be prevented from occurring.

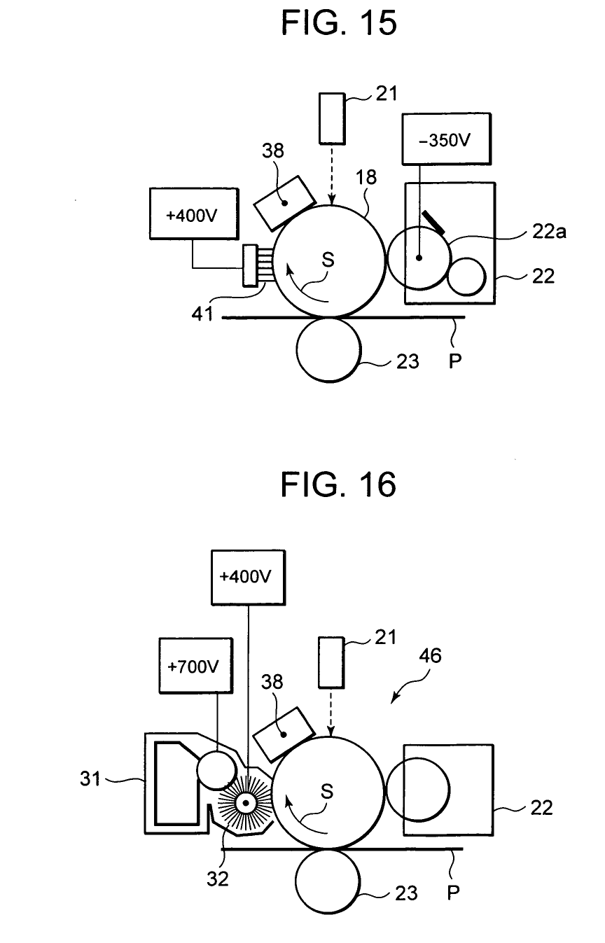

The shape of the disturbing brush in the embodiment is not limited, and a fixed disturbing brush 41 shown in FIG. 15 may also be used.

A fourth embodiment of the invention will be described. The fourth embodiment is to verify the scraped state of the surface of the photoreceptor due to the conductive brush of the first embodiment. The verification was made by using the cleaning brush 32 of the unitized cleaning device 31 of the second embodiment. Therefore, the same constitutions as described in the second embodiment are attached with the same symbols for omitting the detailed descriptions thereof. As shown in FIG. 16, a scorotron charger 38, a laser exposing device 21, a developing device 22, a transfer roller 23 and a cleaning device 31 are sequentially disposed around a photoreceptor drum 18 along the rotation direction shown by the arrow S.

Continuous printing was effected by using various kinds of cleaning brushes, and the scraped states on the surface of the photoreceptor drum 18 were compared. Nylon 6 was used as the fiber resin of the cleaning brush. The pH value of carbon black dispersed in the fiber resin was pH 2.6, pH 4.5 and pH 7.8, and the fineness of the brush fibers was 6 dtex. Titanium dioxide as the inorganic fine particles was added as an additive other than the carbon black. A continuous printing test of 80,000 sheets was carried out with the cleaning brush 32 made in contact with the photoreceptor drum 18, and the average scraped amount and the surface roughness of the surface of the photoreceptor drum and the roughness of an halftone image were evaluated for every 20,000 sheets. The average scraped amount was measured with an eddy current thickness meter (LH-330, produced by Kett Electric Laboratory). The surface roughness was measured with a laser microscope (1LM21, produced by Lasertec Corp.).

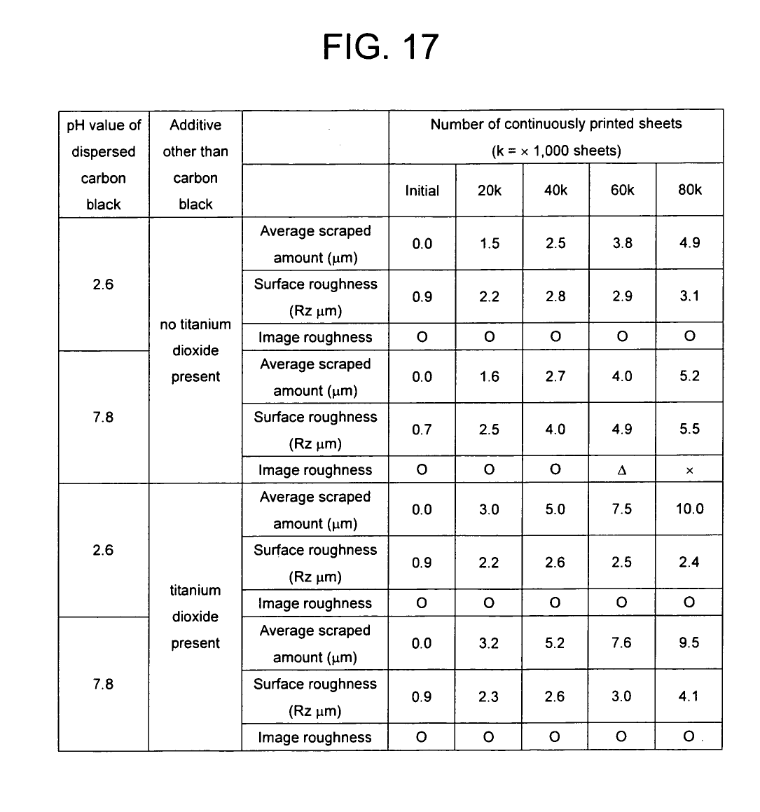

The results are shown in FIG. 17. As a result, in the case where titanium dioxide was not added, there was no large difference in average scraped amount of the photoreceptor drum 18 between the brush of the embodiment having the oxidation-treated carbon black of pH 2.6 dispersed therein and the conventional brush having the carbon black of pH 7.8 dispersed therein. However, the surface roughness was gradually increased with the conventional cleaning brush, but was not increased largely with the cleaning brush 32 of the embodiment beyond the initial 20,000 sheets. The roughness of a halftone image becomes conspicuous under visual observation with the conventional brush around 60,000 sheets, but no increase in roughness was observed finally with the brush of the embodiment.

Accordingly, it was found that the scraping unevenness of the photoreceptor drum 18 was smaller with the cleaning brush 32 of the embodiment having the oxidation-treated carbon black of pH 2.6 dispersed therein as compared to the conventional cleaning brush having the carbon black of pH 7.8 dispersed therein. As a result, it was understood that the cleaning brush 32 of the embodiment could be stably used and could maintain high image quality for a prolonged period of time.

In the case where 3.0% of titanium dioxide as an additive was dispersed in the brush fibers in addition to the carbon black, the scraped amount was increased due to the influence of titanium dioxide as the inorganic fine particles in the conventional cleaning brush. The surface roughness was in a direction of improvement as compared to the case where no titanium dioxide was added, but became 4.1 after completing 80,000 sheets. In the cleaning brush 32 of the embodiment, on the other hand, it was found that the surface roughness became 2.4 after completing 80,000 sheets printing while the scraped amount was increased due to the influence of titanium dioxide, and the photoreceptor drum was scraped extremely uniformly.

It was thus found that the cleaning brush 32 of the embodiment having the oxidation-treated carbon black of pH 2.6 dispersed therein is effective as a measure for uniformly and smoothly scraping the surface of the photoreceptor drum 18. It was also found that the addition of titanium dioxide was effective for scraping smoothly and uniformly while the scraped amount was increased.

As a result, the conductive brush having the oxidation-treated carbon black dispersed therein has an effect of prevention of filming or removal of filming, in which a toner resin, wax, an external additive and the like are attached to the photoreceptor. In general, a toner resin, wax, an external additive and the like are liable to be attached to a photoreceptor having high durability and being hard to be scraped. The filming is such a phenomenon that when the surface of the photoreceptor is in contact with such a means as a contact transferring part, a contact charging part and a cleaning part, the means is fixed to the photoreceptor due to stress applied with the toner or the like present thereon.

Examples of the photoreceptor having high durability include an inorganic photoreceptor containing amorphous silicon (α-Si) as a major component. In an organic photoreceptor, when a photoreceptor containing a positive hole transporting material having a chain-polymerizable functional group is used as shown in JP-A-2005-173566, the photoreceptor is hard to be damaged with high surface hardness and has a prolonged service life.

In the case where the photoreceptors are employed, when the conductive brush having the oxidation-treated carbon black dispersed therein is used as a photoreceptor abrading brush, the photoreceptor itself is substantially not abraded, but only the fixed toner component and the like can be stably removed. As a result, filming on the surface of the photoreceptor can be prevented from occurring. The effect can be obtained by using the conductive brush having the oxidation-treated carbon black dispersed therein of the invention as a charging means, a cleaning means or a disturbing means.

For example, in the case where the conductive charging brush having the oxidation-treated carbon black dispersed therein is used as a charging means, a fine particle toner having a significantly strong adhesion force, which causes filming on the photoreceptor, can be scraped out while the surface of the photoreceptor is charged. Furthermore, a part where filming has been actually occurred can also be scraped out. However, the effect also scrapes the surface of the photoreceptor. Therefore, a photoreceptor having high durability, such as a photoreceptor that is hard to be scraped, and a photoreceptor that is stably scraped averagely, is effective for a stable filming preventing means and a filming removing means.

According to the fourth embodiment of the invention, the conductive brush 12 containing the brush fibers 10 having the oxidation-treated carbon black having good dispersibility dispersed in the fiber resin with a substantially uniform resistance is made in contact with the photoreceptor drum 18 to scrape the surface of the photoreceptor drum 18 averagely and smoothly. According to the constitution, filming on the photoreceptor drum 18 is prevented from occurring, and furthermore, the filming is removed, whereby the service life of the photoreceptor drum 18 is improved.

In the embodiment, the inorganic fine particles added to the brush fibers 10 may be cerium oxide or the like. The conductive brush for preventing filming from occurring on the surface of the photoreceptor drum 18 may be provided separately from the charging means, the cleaning means or the disturbing means.

A fifth embodiment of the invention will be described. In the fifth embodiment, the conductive brush of the first embodiment is used in an image forming part, whereby the burden of maintenance of the image forming apparatus is reduced. In the embodiment, plural image forming parts 46 of the fourth embodiment are disposed in a tandem form as an image forming station in order to gain a color image. Therefore, the same constitutions as described in the fourth embodiment are attached with the same symbols for omitting the detailed descriptions thereof.

In an image forming apparatus, in general, when the frequency of the exchanging operation of an image carrying member, a charging means and a developing means of an image forming part is considerably small, a user can attain maintenance of the image forming apparatus only by exchanging a cleaning means and a toner tank for feeding a toner to a developing means. In this case, when periodical exchange of a developer can be omitted in a developing means of two-component developing with a toner and a carrier, the maintenance property can be improved. In a tandem color image forming apparatus having plural image forming stations for respective colors of toners, particularly, further reduction in burden of maintenance is demanded.

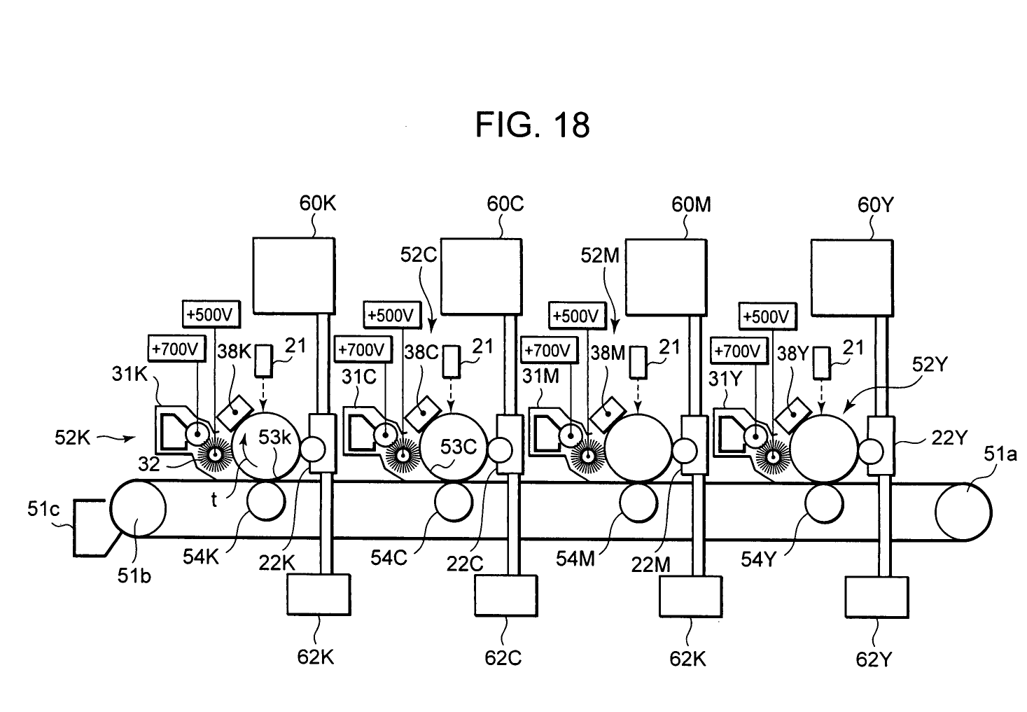

FIG. 18 shows an image forming part 50 of a cleaner system of a quadruple tandem color image forming apparatus of the embodiment. The image forming part 50 has four sets of image forming stations 52Y, 52M, 52C and 52K for yellow (Y), magenta (M), cyan (C) and black (K) along an intermediate transfer belt 51. The intermediate transfer belt 51 is stretched between a driving roller 51a and a driven roller 51b. Numeral 51c denotes a belt cleaner.

The image forming station 52Y of yellow (Y), for example, has a scorotron charger 38Y, a developing device 22Y and a cleaning device 31Y are sequentially disposed around a photoreceptor drum 53Y along the rotation direction shown by the arrow t. In a range from the scorotron charger 38Y to the developing device 22Y around the photoreceptor drum 53Y, light for exposure is radiated from a laser exposure device 21. A transfer roller 54Y is disposed at a position opposite to the photoreceptor drum 53Y with the intermediate transfer belt 51 intervening between them.

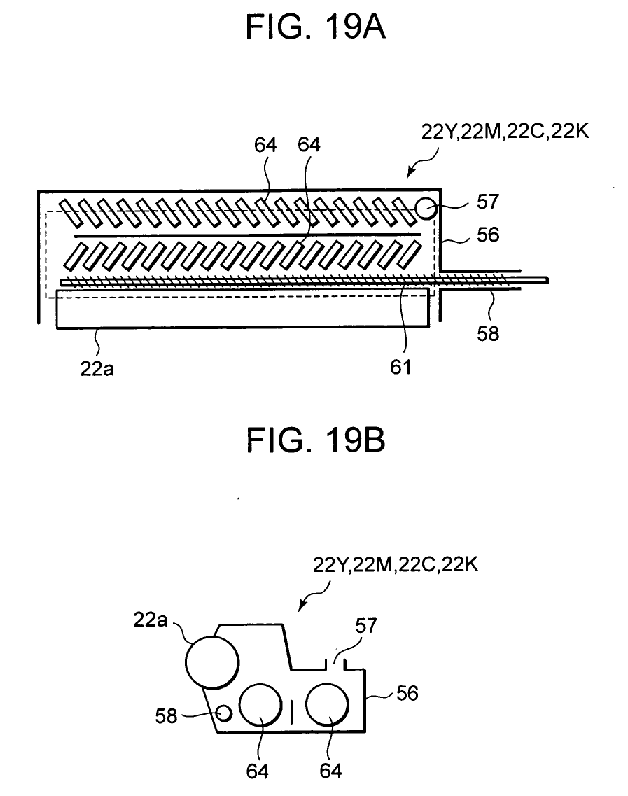

The developing device 22Y employs such a system that a small amount of a developer is replaced. As shown in FIGS. 19A and 19B, a developing container 56 has an inlet 57 for a developer at an upper part and has an outlet 57 at a lower part. From the inlet 57, a developer is fed from a toner feeding tank 60Y for feeding a developer obtained by mixing a yellow (Y) toner and a small amount of a carrier.

The outlet 57 exhausts the developer that is automatically conveyed gradually, from an exhaust auger 61 inside the developing container 56, and conveys the developer to a waste toner tank 62Y. The exhaust amount of the developer from the outlet 58 may be controlled, for example, by the rotation of the exhaust auger 61. A so-called overflow system may be employed, in which a spilled amount of the developer that is increased in amount in the developing container to exceed a prescribed height is exhausted. Furthermore, such a system may be employed that upon feeding the developer, the toner and the carrier are placed into the developing container by controlling them separately.

By employing the developing device 22Y, the operation for exchanging the developer that is carried out after detaching the developing device from the color image forming apparatus main body can be omitted. Since the mechanical service life of a developer for two-component development is a considerably long as from 300,000 to 2,000,000 sheets, a user is freed from the maintenance operation of exchanging the developing device 22Y.

The developing device 22Y employs the system of replacing a small amount of the developer, whereby the developing device 22Y can be miniaturized. In the embodiment, accordingly, a space obtained by miniaturizing the developing device is utilized, whereby a cleaning device of the adjacent image forming station can be disposed at the space, and furthermore, the capacity of the waste toner reservoir 34 of the cleaning device can be increased.

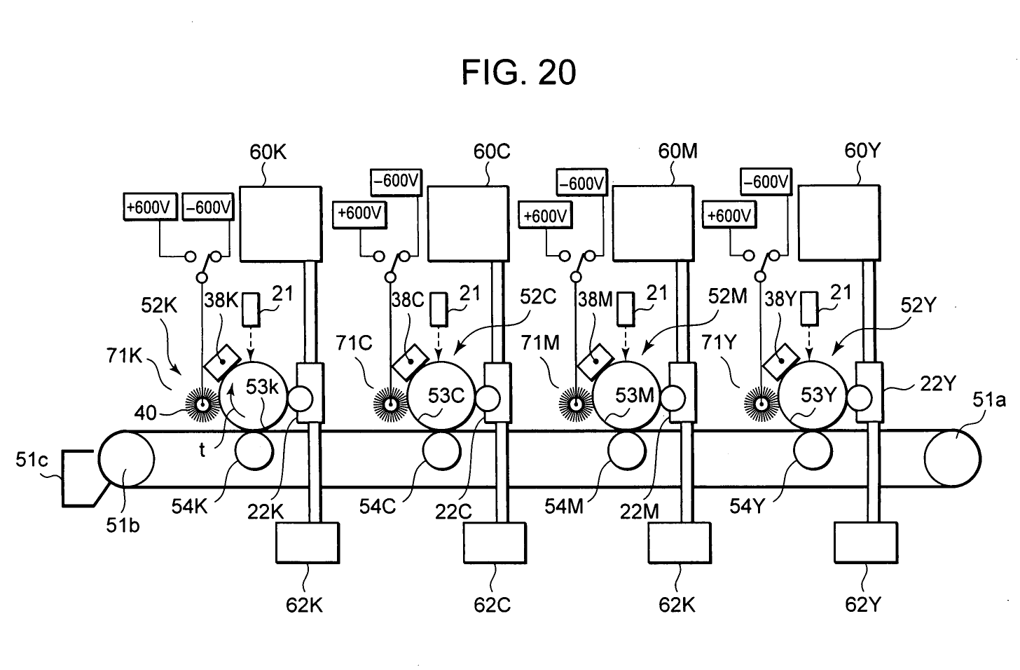

In the case where the capacity of the waste toner reservoir 34 is increased to prevent the waste toner reservoir 34 from being filled to capacity until the service life of the photoreceptor drum 53Y is expired, exchange of the cleaning device 31Y during the use can be omitted. By using a disturbing device 71Y in a cleanerless system as shown in FIG. 20 instead of the cleaner system, the waste toner reservoir 34 can be omitted, and the risk of spill out can be eliminated.

Moreover, the photoreceptor drum 53Y is prevented from suffering from filming, or filming thereon is removed, with the cleaning brush 32 of the cleaning device 31Y, whereby the service life thereof can be prolonged. Accordingly, the photoreceptor drum 53Y, the scorotron charger 38Y and the cleaning device 31Y are integrated and supported to form a cartridge, whereby the cartridge can be exchanged at a time only in the case where the service life of the photoreceptor drum 53Y is expired. According to the constitution, the burden of maintenance of the image forming part 50 by a user can be reduced.

While the image forming station 52Y of yellow (Y) has been described, the image forming stations 52M, 52C and 52K of magenta (M), cyan (C) and black (K) are constituted in the similar manner. In each of the image forming stations 52M, 52C and 52K of magenta (M), cyan (C) and black (K), scorotron chargers 38M, 38C and 38K, developing devices 22M, 22C and 22K and cleaning devices 31M, 31C and 31K are sequentially disposed respectively around photoreceptor drums 53M, 53C and 53K. In ranges from the scorotron chargers 38M, 38C and 38K to the developing devices 22M, 22C and 22K respectively around the photoreceptor drums 53M, 53C and 53K, light for exposure is radiated from a laser exposure device 21. Transfer rollers 54M, 54C and 54K are disposed at positions opposite to the photoreceptor drums 53M, 53C and 53K, respectively, with the intermediate transfer belt 51 intervening between them.

The developing devices 22M, 22C and 22K each employs such a system that a small amount of a developer is replaced, as similar to the developing device 22Y. The developing devices 22M, 22C and 22K are supplied with developers from toner feeding tanks 60M, 60C and 60K, respectively.

The developers exhausted from the outlet 57 of the developing container 56 are conveyed to waste toner tanks 62M, 62C and 62K, respectively.

By employing the system of replacing a small amount of the developer, the developing devices 22M, 22C and 22K are freed from the operation for exchanging the developers that is carried out after detaching the developing devices from the color image forming apparatus main body, and they are miniaturized. Accordingly, in the embodiment, the cleaning devices 31Y, 31M and 31C and the adjacent developing devices 22M, 22C and 22K of the image forming stations 52Y, 52M, 52C and 52K are disposed by nesting each other as shown in FIG. 18, whereby the image forming part 50 is miniaturized. Furthermore, the capacity of the waste toner reservoir 34 of the cleaning device is increased, whereby exchange of the cleaning devices 31M, 31C and 31K can be omitted until the service lives of the photoreceptor drums 53M, 53C and 53K are expired. By using disturbing devices 71M, 71C and 71K in a cleanerless system instead of the cleaning devices 31M, 31C and 31K, the waste toner reservoir 34 can be omitted.

Accordingly, in the embodiment, the cleaning devices 31Y, 31M, 31C and 31K in the stations 52Y, 52M, 52C and 52K are freed from maintenance until the service lives of the photoreceptor drums 53Y, 53M, 53C and 53K are expired, respectively. Therefore, the photoreceptor drums 53Y, 53M, 53C and 53K and the scorotron chargers 38Y, 38M, 38C and 38K and the cleaning devices 31Y, 31M, 31C and 31K around them are integrated and supported to form cartridges for the stations 52Y, 52M, 52C and 52K, respectively, whereby the cartridges can be exchanged at a time only in the case where the service lives of the photoreceptor drums 53Y, 53M, 53C and 53K are expired in the stations 52Y, 52M, 52C and 52K, respectively. According to the constitution, the image forming part 50 can be freed from maintenance.

Moreover, the photoreceptor drums 53Y, 53M, 53C and 53K are prevented from suffering from filming, or filming thereon is removed, whereby the service lives thereof can be prolonged. Accordingly, the photoreceptor drums 53Y, 53M, 53C and 53K may substantially not be exchanged as similar to the developing devices 22Y, 22M, 22C and 22K. By employing an a-Si photoreceptor, a hardened organic photoreceptor or the like, the image forming part 50 can be freed from maintenance. As a result, the developing devices 22Y, 22M, 22C and 22K and the photoreceptor drums 53Y, 53M, 53C and 53K may not be exchanged by a user and can be freed from maintenance. It is possible that a user may exchange only the units of the cleaning devices and the scorotron chargers 38Y, 38M, 38C and 38K.

According to the fifth embodiment, the conductive brush 12 formed of the brush fibers 10, which has a substantially uniform resistance by dispersing the oxidation-treated carbon black having good dispersibility in a fiber resin, is used as the cleaning brush 32 or the disturbing brush 40 for a cleanerless system. According to the constitution, filming on the photoreceptor drums 53Y, 53M, 53C and 53K is prevented from occurring. Simultaneously, the developing devices 22Y, 22M, 22C and 22K employ a system of replacing a small amount of the developer. According to the constitution, a maintenance operation of exchanging the developers by taking out the developing devices 22Y, 22M, 22C and 22K from the image forming part can be omitted, and the developing devices 22Y, 22M, 22C and 22K can be miniaturized. Moreover, the capacity of the waste toner reservoir 34 of the cleaning devices 31Y, 31M, 31C and 31K can be increased.

According to the constitution, in the image forming stations 52Y, 52M, 52C and 52K, the service lives of the photoreceptor drums 53Y, 53M, 53C and 53K are prolonged, the developing devices 22Y, 22M, 22C and 22K are completely freed from maintenance, and the exchange frequencies of the cleaning devices 31Y, 31M, 31C and 31K can be reduced. For example, the scorotron chargers 38Y, 38M, 38C and 38K and the cleaning devices 31Y, 31M, 31C and 31K are integrated to form process cartridges in the image forming stations 52Y, 52M, 52C and 52K, respectively. According to the constitution, the maintenance operation can be carried out considerably easily only by exchanging the process cartridge. Therefore, the burden of maintenance of the image forming part 50 can be significantly reduced even though it has a quadruple tandem system. Moreover, there is no such a risk that a toner is spilled out from the cleaning brush 32 upon maintenance to contaminate the surrounding of the image forming part 50.

In the embodiment, the constitution of the process cartridge is not limited and may be arbitrarily determined in such manners that a photoreceptor drum and only a cleaning device containing a conductive brush are constituted as a unit, and a photoreceptor drum and a charging device containing a conductive brush are constituted as a unit. Accordingly, a mechanism that is capable of being exchanged simultaneously with a photoreceptor drum may be integrated with the photoreceptor drum to form a process cartridge. The process cartridge may be used in an image forming part of a monochrome image forming apparatus.

The invention is not limited to the aforementioned embodiments, and various changes may be made within the scope of the invention. For example, the pH value of the oxidation-treated carbon black dispersed in the conductive brush is not limited as far as it is 4.5 or less, the fiber resin used may be arbitrarily selected, and the thickness of the brush fibers may be changed depending on necessity.

What is claimed is:

1. A conductive brush comprising:
a substrate; and
conductive fibers comprising conductive carbon black having been subjected to an oxidation treatment dispersed in a resin and being attached in a brush form on the substrate.

2. The conductive brush as claimed in claim 1, wherein the conductive carbon black has pH 4.5 or less.

3. The conductive brush as claimed in claim 2, wherein the resin contains a polyamide resin as a major component.

4. The conductive brush as claimed in claim 2, wherein the resin contains a polyester resin as a major component.

5. The conductive brush as claimed in claim 2, wherein the conductive fibers have a fineness of 9 dtex or less.

6. The conductive brush as claimed in claim 2, wherein the conductive fibers further comprise inorganic fine particles.

7. The conductive brush as claimed in claim 2, wherein the conductive fibers have such a structure that the conductive carbon black is uniformly dispersed in the resin.

8. The conductive brush as claimed in claim 2, wherein the conductive fibers have a core/shell structure having a core part and an outer part different in composition.

9. The conductive brush as claimed in claim 2, wherein the conductive fibers have a multifilament structure containing plural monofilaments.

10. The conductive brush as claimed in claim 2, wherein the conductive fibers woven in a pile form on the substrate have tips in a brush form with exposed cross sections of the conductive fibers.

11. The conductive brush as claimed in claim 2, wherein the conductive brush is a charging member being applied with a bias and being made in contact with an image carrying member of an electrophotographic image forming apparatus with a speed difference, so as to charge the image carrying member.

12. The conductive brush as claimed in claim 2, wherein the conductive brush is a cleaning member having a roller shape, being applied with a bias, and being made in contact with an image carrying member of an electrophotographic image forming apparatus with a speed difference, so as to clean the image carrying member.

13. The conductive brush as claimed in claim 12, wherein the conductive brush has a recovery mode of recovering a toner on the image carrying member, and a returning mode of returning the recovered toner to the image carrying member.

14. The conductive brush as claimed in claim 2, wherein the conductive brush is a disturbing member being applied with a bias and being made in contact with an image carrying member of an electrophotographic image forming apparatus, so as to disturb a toner image on the image carrying member.

15. A process cartridge comprising:
an image carrying member, on which a toner image is formed; and
a conductive brush comprising conductive carbon black of pH 4.5 or less dispersed in a resin, the conductive brush being capable of freely detached from an image forming apparatus main body, as integrated with the image carrying member, and being made in contact with the image carrying member.

16. The process cartridge as claimed in claim 15, wherein the image carrying member contains a positive hole transporting material having a chain-polymerizable functional group.

17. The process cartridge as claimed in claim 15, wherein the conductive brush is a charging member being applied with a bias and being made in contact with the image carrying member with a speed difference, so as to charge the image carrying member.

18. The process cartridge as claimed in claim 15, wherein the conductive brush is a cleaning member having a roller shape, being applied with a bias, and being made in contact with the image carrying member with a speed difference, so as to clean the image carrying member.

19. The process cartridge as claimed in claim 15, wherein the conductive brush is a disturbing member being applied with a bias and being made in contact with the image carrying member, so as to disturb a toner image on the image carrying member.

20. An image forming apparatus comprising:
an image forming station forming a toner image on an image carrying member by an electrophotographic system; and
a conductive brush comprising conductive fibers comprising conductive carbon black of pH 4.5 or less dispersed in a resin, the conductive brush being made in contact with the image carrying member.
